(19) United States
(12) Patent Application Publication
(10) Pub. No.: US 2026/0261833 A1
(43) Pub. Date: Sep. 3, 2026

(54) DISTRIBUTION OF MOVEMENT WARNING INFORMATION FOR COMMUNICATION DEVICE MOVING ALONG WITH MOVING STATION

(71) Applicant: RAKUTEN MOBILE, INC., Tokyo (JP)

(72) Inventor: Kenichiro AOYAGI, Tokyo (JP)

(21) Appl. No.: 18/725,810

(22) PCT Filed: Oct. 31, 2023
(86) PCT No.: PCT/JP2023/039195

§ 371 Date: Jul. 1, 2024

(51) Int. Cl. H04W 4/90; H04W 64/00

(52) U.S. Cl. CPC H04W 4/90; H04W 64/006

(57) ABSTRACT

A communication control apparatus includes at least one processor that performs: causing an emergency information acquirer to acquire emergency information concerning an emergency information distribution area in which a movable moving station is located; causing a moving communication device identifier to identify a moving communication device that moves along with the moving station; causing a movement warning information generator to generate movement warning information concerning the emergency information and the movement of at least one of the moving station and the moving communication device; and causing an information distributer to distribute the movement warning information from the moving station to the moving communication device.

### TECHNICAL FIELD

The present disclosure relates to distribution of movement warning information for communication device moving along with moving station.

### BACKGROUND ART

Number, types, and applications of wireless communication devices, hereinafter also collectively referred to as communication device, represented by smartphones or Internet of Things (IoT) devices, continue to increase. Wireless communication standards also continue to be expanded or improved. The commercial service of the fifth-generation mobile communication system known as “5G”, for example, started in 2018, and efforts still continue by 3GPP (Third Generation Partnership Project) for further developing its standards or specifications. Preliminary works have also started to develop new standards for “6G” or the sixth-generation mobile communication system, which would be the next-generation wireless communication standards following 5G.

### CITATION LIST

### Patent Literature

[PATENT LITERATURE 1] Patent Literature 1: US Patent Application Publication No. 2021/0168643

### SUMMARY OF INVENTION

### Technical Problem

In a mobile communication system, an emergency information distribution area is set up in which disasters such as earthquakes or tsunamis and other emergency information is distributed simultaneously. Here, the emergency information distribution areas are generally set up in units of administrative divisions such as cities, wards, towns, and villages. Therefore, only the distribution of outline information common to each administrative division is allowed.

The present disclosure has been made in consideration of such circumstances for providing a communication control apparatus or the like that can distribute information highly relevant to a communication device in an emergency situation.

### Solution to Problem

A communication control apparatus in one embodiment of the present disclosure includes at least one processor that performs: causing an emergency information acquirer to acquire emergency information concerning an emergency information distribution area in which a movable moving station is located; causing a moving communication device identifier to identify a moving communication device that moves along with the moving station; causing a movement warning information generator to generate movement warning information concerning the emergency information and the movement of at least one of the moving station and the moving communication device; and causing an information distributer to distribute the movement warning information from the moving station to the moving communication device.

According to the embodiment, in an emergency situation where emergency information is distributed simultaneously, the movement warning information concerning movement is distributed from the moving station to the moving communication device that moves along with the moving station. The movement warning information is more relevant to the moving communication device than the emergency information that is distributed simultaneously within the emergency information distribution area.

Another embodiment of the present disclosure is a communication control method. The communication control method causes at least one processor to perform: acquiring emergency information concerning an emergency information distribution area in which a movable moving station is located; identifying a moving communication device that moves along with the moving station; generating movement warning information concerning the emergency information and the movement of at least one of the moving station and the moving communication device; and distributing the movement warning information from the moving station to the moving communication device.

Further another embodiment of the present disclosure is a computer-readable medium storing a communication control program. The communication control program causes at least one processer to perform: acquiring emergency information concerning an emergency information distribution area in which a movable moving station is located; identifying a moving communication device that moves along with the moving station; generating movement warning information concerning the emergency information and the movement of at least one of the moving station and the moving communication device; and distributing the movement warning information from the moving station to the moving communication device.

It should be noted that any combination of the above components, or any conversion of the expression of the present disclosure among methods, devices, systems, storage media, computer programs or the like, are also encompassed within the present disclosure.

### Advantageous Effects of Invention

According to the present disclosure, information highly relevant to a communication device in an emergency situation can be distributed.

### BRIEF DESCRIPTION OF DRAWINGS

FIG. 1 schematically shows an overview of a wireless communication system to which the communication control apparatus is applied; FIG. 2 schematically shows the general configuration of the wireless communication system to which the communication control apparatus is applied; FIG. 3 is a functional block diagram of the communication control apparatus; and FIG. 4 schematically shows an example of processes by a position information acquirer and an emergency information distribution area setter.

### DESCRIPTION OF EMBODIMENTS

The following is a detailed description of an exemplary implementation of the present disclosure, hereinafter also referred to as embodiment, with reference to the drawings. In the description or the drawings, identical or equivalent components, parts, processes or the like will be given the same symbol to omit duplicate descriptions. The scale or shape of each portion shown in the drawings is set for convenience to simplify the description. Therefore, any of them should not be interpreted as limiting unless otherwise noted. Such illustrative embodiments will not limit the coverage of the present disclosure in any way. Not all features presented in the embodiments or combinations thereof are necessarily essential to the present disclosure.

The presented embodiments are broken down into respective components to realize each function or each function group for convenience. However, one component in an embodiment may actually be realized by a combination of a plurality of separate components. Conversely, a plurality of components in an embodiment may actually be realized by a single united component. In the descriptions of the wireless communication system according to the present embodiment, the terms in existing wireless communication standards such as 5G are used for convenience. This is not intended to limit the present disclosure to 5G or the like. Rather, the present disclosure can be applied to future wireless communication systems such as 6G, even if technologies similar to the present disclosure are provided under different names.

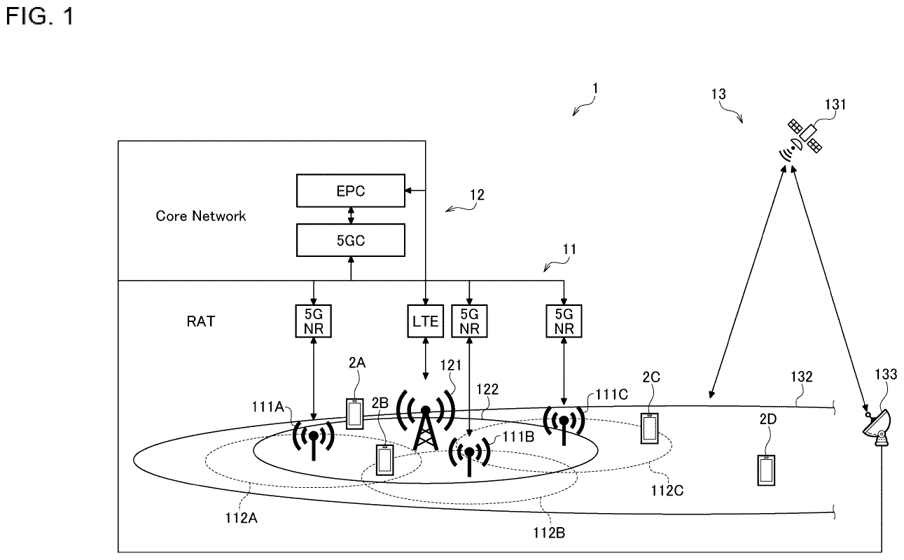

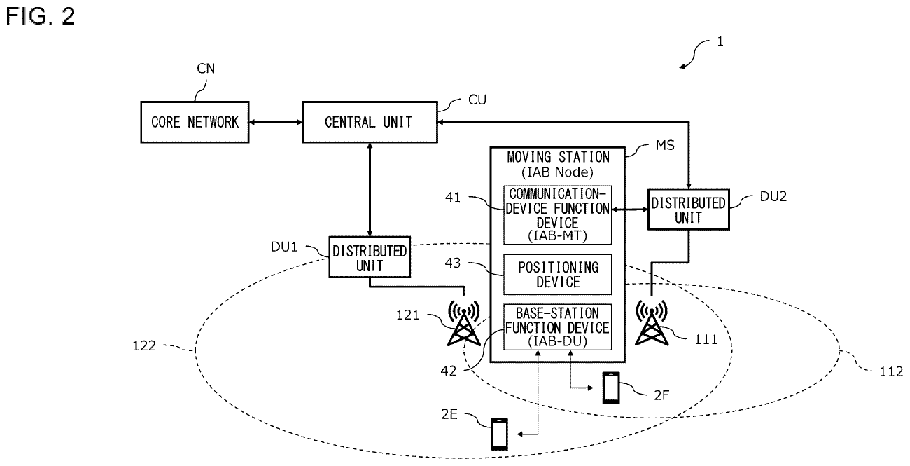

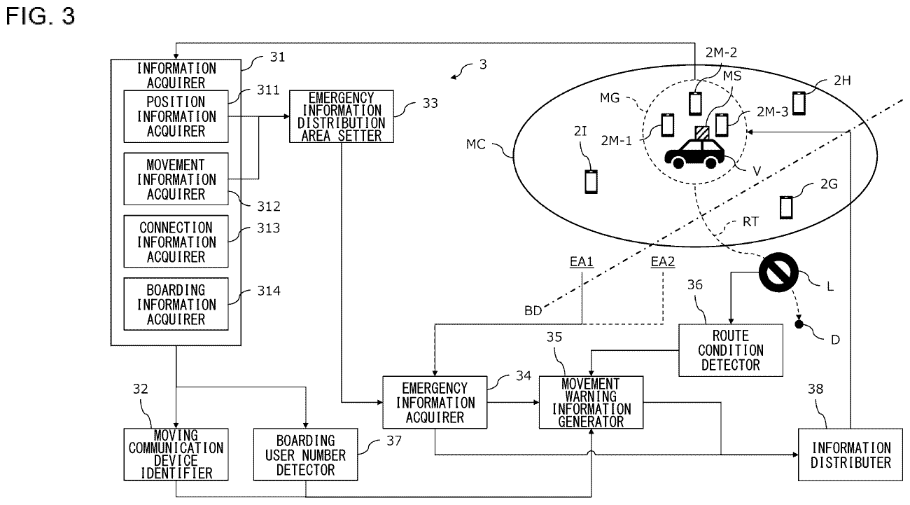

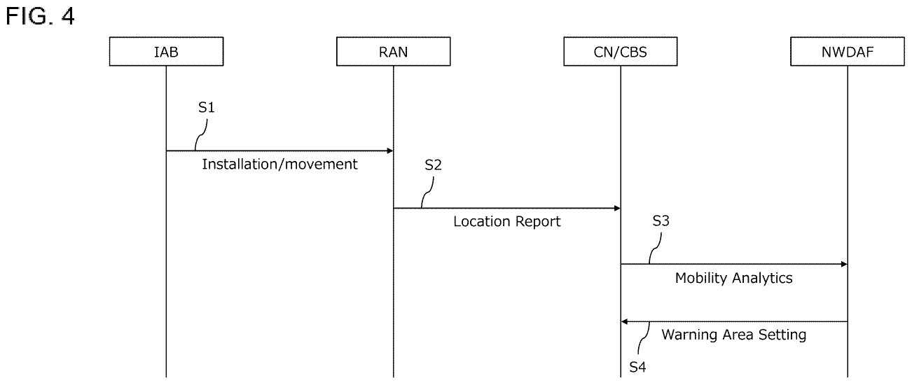

FIG. 1 schematically shows an overview of a wireless communication system 1 to which the communication control apparatus according to an embodiment of the present disclosure is applied. The wireless communication system 1 includes a 5G wireless communication system 11, a 4G wireless communication system 12, and a satellite communication system 13. The 5G wireless communication system 11 complies with the fifth-generation mobile communication (5G) system. The 5G system uses NR (New Radio) or 5G NR (Fifth Generation New Radio) as the radio access technology (RAT), and uses 5GC (Fifth Generation Core) as the core network (CN). The 4G wireless communication system 12 complies with the fourth-generation mobile communication (4G) system. The 4G system uses LTE (Long Term Evolution) or LTE-Advanced as the radio access technology, and uses EPC (Evolved Packet Core) as the core network. The satellite communication system 13 handles satellite communication via a communication satellite 131. Although not shown in the figure, the wireless communication system 1 may include: wireless communication systems of a generation prior to 4G; wireless communication systems of a generation later than 5G such as 6G; and any wireless communication systems not associated with those generations such as Wi-Fi (registered trademark). The wireless communication system 1 may not include some or all of the 5G wireless communication system 11, the 4G wireless communication system 12, and the satellite communication system 13.

The 5G wireless communication system 11 includes a plurality of 5G base stations 111A, 111B, and 111C installed on the ground, hereinafter also collectively referred to as 5G base station 111. The 5G base station 111 can communicate through 5G NR with communication devices 2A, 2B, 2C, and 2D, hereinafter also collectively referred to as communication device 2. The communication device 2 such as smartphone is also referred to as UE (User Equipment) or UT (User Terminal). The 5G base station 111 is also referred to as gNodeB (gNB). The coverage or support range of the respective 5G base stations 111A, 111B, and 111C is referred to as a cell. The respective cells 112A, 112B, and 112C, hereinafter also collectively referred to as 5G cell 112, is illustrated in the figure.

The size of the 5G cell 112 by the 5G base station 111 is freely selected, but typically ranges from a few meters to several tens of kilometers in radius. Although there is no established definition, a cell with a radius of a few meters to ten meters may be called a femtocell, a cell with a radius of ten meters to several tens of meters may be called a picocell, a cell with a radius of several tens of meters to several hundreds of meters may be called a microcell, and a cell with a radius of more than several hundreds of meters may be called a macrocell. In 5G, high frequency radio waves such as millimeter waves are often used. Their high tendency to propagate in a straight-line causes the radio waves to be blocked by obstacles, shortening the communication distance. For this reason, 5G tends to use more small cells than 4G and earlier generations.

The communication device 2 can perform the 5G communication when it is located within at least one of the plurality of 5G cells 112A, 112B, and 112C. In the example shown in the figure, the communication device 2B in the 5G cells 112A and 112B can communicate with both the 5G base stations 111A and 111B through 5G NR. The communication device 2C in the 5G cell 112C can communicate with the 5G base station 111C through 5G NR. The communication devices 2A and 2D cannot communicate through 5G NR, as they are outside of all the 5G cells 112A, 112B, and 112C. The 5G communication based on 5G NR between each communication device 2 and each 5G base station 111 is managed by the 5GC as the core network. For example, the 5GC: transfers data to and from each 5G base station 111; transfers data to and from external networks such as the EPC, the satellite communication system 13, and the Internet; and handles mobility management of the communication device 2.

The 4G wireless communication system 12 includes a plurality of 4G base stations 121 installed on the ground (only one of them is illustrated in FIG. 1). The plurality of 4G base stations 121 can communicate through LTE or LTE-Advanced with the communication device 2. The 4G base station 121 is also referred to as eNodeB (eNB). The coverage or support range of the respective 4G base stations 121 is referred to as a cell, similar to the respective 5G base stations 111. Such a 4G cell 122 is illustrated in the figure.

The communication device 2 can perform the 4G communication when it is located within the 4G cell 122. In the example shown in the figure, the communication devices 2A and 2B in the 4G cell 122 can communicate with the 4G base station 121 through LTE or LTE-Advanced. The communication devices 2C and 2D cannot communicate through LTE or LTE-Advanced, as they are outside of the 4G cell 122. The 4G communication based on LTE or LTE-Advanced between each communication device 2 and each 4G base station 121 is managed by the EPC as the core network. For example, the EPC: transfers data to and from each 4G base station 121; transfers data to and from external networks such as the 5GC, the satellite communication system 13, and the Internet; and handles mobility management of the communication device 2.

If we take a look at each communication device 2A, 2B, 2C, and 2D in the example shown in the figure, the communication device 2A can perform the 4G communication with the 4G base station 121, the communication device 2B can perform the 5G communication with the 5G base stations 111A and 111B and the 4G communication with 4G base station 121, and the communication device 2C can perform the 5G communication with the 5G base station 111C. In case one communication device 2 (e.g., 2B) can communicate with a plurality of base stations (e.g., 111A, 111B, and 121), one base station is selected under the control of the 5GC or the EPC as the core network. For example, one base station is selected as the most suitable for the communication device 2B based on communication quality or the like. The communication device 2D cannot perform the communication with any of the 5G base stations 111 nor any of the 4G base stations 121. Therefore, the communication device 2D would perform the communication through the satellite communication system 13 described below.

The satellite communication system 13 is a wireless communication system using communication satellites 131 as non-terrestrial base stations. The communication satellite 131 may be a low-earth-orbit satellite flying in the low-earth-orbit outer space with altitude of 500 to 700 km above the ground. The coverage or support range of the communication satellite 131 is referred to as a cell, similar to the 5G base station 111 and the 4G base station 121. Such a satellite communication cell 132 is illustrated in the figure. As such, the communication satellite 131 as a non-terrestrial base station provides a satellite communication cell 132 as a non-terrestrial communication cell onto the ground. The communication device 2 on the ground can perform the satellite communication when it is located within the satellite communication cell 132. The communication satellite 131 as the base station in the satellite communication system 13 can perform wireless communication with the communication device 2 within the satellite communication cell 132, similar to the 5G base station 111 in the 5G wireless communication system 11 and the 4G base station 121 in the 4G wireless communication system 12. Such a wireless communication between the communication satellite 131 and the communication device 2 may be performed directly or indirectly via an aircraft or the like. The radio access technology used by the communication satellite 131 for wireless communication with the communication device 2 in the satellite communication cell 132 may be: 5G NR used by the 5G base station 111; LTE or LTE-Advanced used by the 4G base station 121; or any other radio access technology available for the communication device 2. Therefore, the communication device 2 does not have to be equipped with any special functions or components for the satellite communication.

The satellite communication system 13 is equipped with a gateway 133 as a ground station installed on the ground. The gateway 133 can communicate with the communication satellite 131. The gateway 133 is equipped with a satellite antenna for communicating with the communication satellite 131. The gateway 133 is also connected to the 5G base station 111 or the 4G base station 121 as the terrestrial base station that constitutes a terrestrial network (TN). Such a connection between the gateway 133 and the terrestrial base station can be established via: the above radio access technology such as 5G NR and LTE; or another wired or wireless access technology or interface. In such a manner, the gateway 133 connects the non-terrestrial network (NTN) constituted by the communication satellite 131 as the non-terrestrial base station or the satellite base station, and the terrestrial network TN constituted by the terrestrial base station 111 and 121. That is, the mutual communication between the non-terrestrial network NTN and the terrestrial network TN can be established via the gateway 133. In case the communication satellite 131 performs the 5G communication with the communication device 2 in the satellite communication cell 132 through 5G NR, the 5GC is used as the core network. In such a case, the communication satellite 131 is connected to the 5GC via the gateway 133, and the communication device 2 is connected to the 5GC via the 5G base station 111 or the 5G radio access network in the TN. In case the communication satellite 131 performs the 4G communication with the communication device 2 in the satellite communication cell 132 through LTE or LTE-Advanced, the EPC is used as the core network. In such a case, the communication satellite 131 is connected to the EPC via the gateway 133, and the communication device 2 is connected to the EPC via the 4G base station 121 or the 4G radio access network in the TN. In such a manner, appropriate coordination is made among different wireless communication systems such as the 5G wireless communication system 11, the 4G wireless communication system 12, and the satellite communication system 13 via the gateway 133.

The satellite communication through the communication satellites 131 is mainly used for covering areas with no or few terrestrial base stations such as the 5G base station 111 and the 4G base station 121. In the example shown in the figure, the communication device 2D located outside all the communication cells by the terrestrial base stations would communicate with the communication satellite 131. On the other hand, the communication devices 2A, 2B, and 2C also located inside the satellite communication cell 132 would not communicate with the communication satellite 131 in principle, even if they can. This is because they are in good communication with either of the terrestrial base stations. As such, the communication devices 2A, 2B, and 2C would communicate with the terrestrial base stations instead of the communication satellite 131, thereby saving the limited communication resources including power of the communication satellite 131 for use by the communication device 2D or the like. The communication satellite 131 uses beamforming to direct the communication radio waves to the communication device 2D in the satellite communication cell 132, thereby improving the communication quality with the communication device 2D.

The size of the satellite communication cell 132 by the communication satellite 131 as the satellite base station depends on the number of beams emitted by the communication satellite 131. For example, the satellite communication cell 132 with a diameter of approximately 24 km can be formed by combining up to 2,800 beams. As illustrated, the satellite communication cell 132 is typically larger than a terrestrial communication cell such as the 5G cell 112 and the 4G cell 122. Such a satellite communication cell 132 could contain one or more 5G cells 112 or 4G cells 122 inside it. The above example shows the communication satellite 131 as a flying non-terrestrial base station, which flies in the low-earth-orbit outer space with altitude of 500 to 700 km above the ground. However, a communication satellite flying in the geostationary orbit or other higher orbit in outer space, or an unmanned or manned aircraft or a drone flying in the stratosphere or other lower (e.g., approximately 20 km above the ground) atmosphere may be used as a non-terrestrial base station in addition to or instead of the communication satellite 131.

FIG. 2 schematically shows the general configuration of the wireless communication system 1 to which the communication control apparatus according to the embodiment of the present disclosure is applied. As shown in FIG. 1, the wireless communication system 1 is usually constructed by the terrestrial communication cells 112 or 122 (hereinafter also referred to as fixed communication cells) provided by terrestrial base stations 111 or 121 stationarily installed on the ground (hereinafter also referred to as fixed base stations). However, mobile communication cannot be performed outside the fixed communication cells, and the quality of mobile communications might be low depending on time or place even within the fixed communication cells. It should be noted that although the wireless communication system 1 can also include the satellite communication system 13 that uses the communication satellite 131 as a non-terrestrial base station or moving base station, it is impractical to supplement the terrestrial network by the terrestrial base stations 111 or 121 solely by the communication satellites 131.

In order to address such issues, as schematically shown in FIG. 2, it is preferable to introduce a moving station MS for supplementing the fixed communication cells 112 or 122 provided by the fixed base stations 111 or 121. The movable moving station MS can provide a dynamic communication cell, which can vary in space or in time, to the communication device 2. For example, the moving station MS that is actually moving provides a spatially varying (i.e., moving) dynamic communication cell.

It should be noted that the moving station MS, for example, may be a communication station whose operating time is limited to a specific time period, or it may be an on-demand communication station that can be adaptively switched between an inactive state and an active state in accordance with the communication demand of the communication device or the like. Besides, the moving station MS may be a small base station that can independently provide a preferably small communication cell such as a femtocell, a picocell, a microcell or the like, without relying on another large base station such as the terrestrial base station 111 or 121 stationarily installed on the ground or the communication satellite 131, or a relay station that communicates with the existing base station or the parent base station 111, 121, or 131 (not shown in FIG. 2) for expanding the existing communication cell or the parent communication cell 112, 122, or 132 (not shown in FIG. 2). The moving station MS in the examples of FIG. 2 and FIG. 3 is the IAB (Integrated Access and Backhaul) node or the MBSR (Mobile Base Station Relay) that functions as a relay station.

The IAB is a technology specified in 5G to expand a communication cell of a parent node, utilizing wireless backhaul between a base station that serves as the IAB donor (the parent node) and the IAB node (the child node), or between the parent and the child IAB nodes (in which case, the IAB node near to the IAB donor is the parent node, and the IAB node far from the IAB donor is the child node). Here, “expansion of a communication cell” includes not only expanding the area covered by an existing communication cell, but also improving the communication quality of at least a portion of an existing communication cell. Furthermore, “expansion of the area covered by a communication cell” includes not only expanding the area of an existing communication cell in the horizontal plane, but also expanding an existing communication cell vertically, e.g., underground or to the upper or lower floors of a building.

In FIG. 2, the moving station MS as the IAB node includes a communication-device function device 41 that functions as a communication device for the parent node (the parent base station) including the fixed base station 111 or 121 and a base-station function device 42 that functions as the child base station for the communication device 2 for providing a moving communication cell or a relay communication cell. In 5G, the communication-device function device 41 is specified as the MT (Mobile Termination) or the IAB-MT, and the base-station function device 42 is specified as the DU (Distributed Unit) or the IAB-DU. It should be noted that, in other wireless communication systems including generations after 5G, functions similar to the IAB, the MT, the DU, or the CU (Central Unit described below) may be provided under different names. Such similar functions may be utilized as the IAB, the MT, the DU, or the CU in the present embodiment.

Two fixed base stations 111 and 121 are illustrated in FIG. 2. The first fixed base station 121 as a 4G base station provides the first fixed communication cell 122 as a 4G cell, and the second fixed base station 111 as a 5G base station provides the second fixed communication cell 112 as a 5G cell. In the example of FIG. 2, the baseband function of each fixed base station 111 and 121 is divided into a central unit (CU) on the core network CN side and a distributed unit (DU) on the communication device 2 side. The first distributed unit DU1 of the first fixed base station 121 is provided near the radio equipment such as an antenna of the first fixed base station 121, typically in the same base station facility as the radio equipment. The second distributed unit DU2 of the second fixed base station 111 is provided near the radio equipment such as an antenna of the second fixed base station 111, typically in the same base station facility as the radio equipment. Although the central unit CU in the example of the figure is shared by the first fixed base station 121 (the first distributed unit DU1) and the second fixed base station 111 (the second distributed unit DU2), separate central units may be provided for each of the fixed base stations 111 and 121. The central unit CU is connected to the core network CN. The connection between the radio equipment such as an antenna in each of the fixed base stations 111 and 121 and each of the distributed units DU1 and DU2, the connection between each of the distributed units DU1 and DU2 and the central unit CU, and the connection between the central unit CU and the core network CN, are typically wired by conductors, optical fibers or the like, but some or all of the connections may be wireless.

The communication-device function device 41 (IAB-MT) of the moving station MS, depending on the position of the moving station MS, can connect wirelessly with the distributed unit DU of either the fixed base station 111 or 121. In the example of FIG. 2, the communication-device function device 41 is connected wirelessly to the second distributed unit DU2 of the second fixed base station 111. In such a case, the moving station MS functions as the child node for the second fixed base station 111 as the parent node (the parent base station) or the IAB donor, and expands the second fixed communication cell 112 by the second fixed base station 111 as the parent node. Then, the base-station function device 42 (IAB-DU) of the moving station MS provides a moving communication cell (not shown) as an expanded communication cell of the second fixed communication cell 112 to the communication device 2. In the example of FIG. 2, two communication devices 2E and 2F connected to the base-station function device 42 of the moving station MS are schematically shown. The first communication device 2E being inside the first fixed communication cell 122 and outside the second fixed communication cell 112, substantially communicates with the second fixed base station 111 via the moving station MS. The second communication device 2F being inside the overlapping area of the first fixed communication cell 122 and the second fixed communication cell 112, substantially communicates with the second fixed base station 111 via the moving station MS. It should be noted that the moving station MS as the IAB node may expand a moving communication cell such as the satellite communication cell 132 or a non-terrestrial communication cell, with a moving base station such as the communication satellite 131 or a non-terrestrial base station as the parent base station.

The movable moving station MS is attached to a movable object, except in case it can move or fly autonomously like the communications satellite 131. A movable object is any movable thing or person, and includes, for example, automobiles, trains, motorcycles, bicycles, airplanes, drones, ships, and any other vehicles. Besides, the movable moving station MS may be a communication device 2 held by a moving person, for example, a communication device 2 equipped with a tethering function or personal hotspot function. Since such a communication device 2 (the moving station MS) usually functions as a wireless LAN access point, the RAT (e.g., 5G NR) used by the base station to be expanded (e.g., the second fixed base station 111) and the RAT used by the expanding moving station MS may be different.

In addition to the communication-device function device 41 and the base-station function device 42, the moving station MS may have a positioning device 43 capable of positioning the moving station MS itself or the communication device 2 being connected.

The positioning device 43 may be a satellite positioning device such as a GPS module that acquires position information of the moving station MS itself, based on a satellite positioning system such as the GPS or the GNSS (Global Navigation Satellite System). For example, the positioning device 43 such as a GPS module may receive satellite positioning radio waves from a plurality of positioning satellites (not shown) that constitute a satellite positioning system, and calculate the position information of the moving station MS based on the respective transmission times or the like.

The positioning device 43 may estimate the position information of the communication device 2, based on the communication between the moving station MS (the base-station function unit 42) and the communication device 2. For example, the time or the delay required for the communication between the moving station MS and the communication device 2 indicates the distance between the moving station MS and the communication device 2. Besides, in case the moving station MS has a function such as beamforming, the orientation of the antenna of the moving station MS in communication with the communication device 2, or the transmission direction or the reception direction of the beam indicates the direction in which the communication device 2 is located with respect to the moving station MS. Based on such relative distance or direction of the communication device 2 with respect to the moving station MS, the positioning device 43 can estimate the position information of the communication device 2.

The positioning device 43 may acquire the position information of the communication device 2, through positioning electromagnetic waves emitted by one of the moving station MS and the communication device 2 to the other. For example, the moving station MS emits positioning electromagnetic waves or positioning light, preferably with a wavelength or a frequency different from that of the communication radio waves, to the communication device 2. The communication device 2 may notify the time or the intensity of the received positioning electromagnetic wave to the positioning device 43 through the communication with the base-station function unit 42. Based on the transmission time, the transmission strength, the transmission direction or the like of the positioning electromagnetic wave at the positioning device 43, in addition to such a reception time or a reception strength of the positioning electromagnetic wave at the communication device 2, the positioning device 43 can calculate the position information of the communication device 2. It should be noted that instead of or in addition to the electromagnetic wave, any physical phenomenon capable of contactless distance measurement, such as sound, vibration, wave or the like, may be utilized to acquire the position information of the communication device 2 relative to the moving station MS.

FIG. 3 is a functional block diagram of the communication control apparatus 3 according to the present embodiment. The communication control apparatus 3 includes an information acquirer 31, a moving communication device identifier 32, an emergency information distribution area setter 33, an emergency information acquirer 34, a movement warning information generator 35, a route condition detector 36, a boarding user number detector 37, and an information distributer 38. Some of the functional blocks can be omitted as long as the communication control apparatus 3 realizes at least some of the operations or the effects described below. The functional blocks are realized by the cooperation of hardware resources and software to be executed using them. Examples of such hardware resources include a central processing unit, a memory, an input device, and an output device of a computer, or a peripheral device connected to the computer. The types or the installation locations of the computer are freely selected. Each of the above functional blocks may be realized by hardware resources of a single computer, or by combining hardware resources distributed across a plurality of computers. In particular, in the present embodiment, some or all of the functional blocks of the communication control apparatus 3 are preferably realized in the core network CN. However, they may be realized in a centralized manner or a distributed manner in a computer or a processor provided in the base station 111, 121, or 131 (the distributed unit DU or the central unit CU), the gateway 133, the moving station MS, the vehicle V, or the communication device 2.

In the example of FIG. 3, the moving station MS as the IAB node is movable, being attached to the vehicle V such as a car or a train. The moving station MS provides the moving communication cell MC as the expanded communication cell of the communication cell 112, 122, or 132 (not shown) provided by the base station 111, 121, or 131 (not shown) to the communication device 2. In FIG. 3, six communication devices 2G, 2H, 21, 2M-1, 2M-2, and 2M-3 (hereinafter also collectively referred to as communication device 2) are shown schematically and exemplarily within the moving communication cell MC.

Among them, the three non-moving communication devices 2G, 2H, and 2I are outside the vehicle V, and the three moving communication devices 2M-1, 2M-2, and 2M-3 (hereinafter also collectively referred to as moving communication device 2M) are inside the vehicle V as shown schematically by the dotted line. The moving communication device 2M in the vehicle V can be used by a user (not shown) boarding on the vehicle V, and can move along with the vehicle V and the moving station MS. The moving communication device 2M, the vehicle V, and the moving station MS, which move together in such a manner, are also collectively referred to as a moving group MG.

The six communication devices 2G, 2H, 21, 2M-1, 2M-2, and 2M-3 shown in FIG. 3 are all in the moving communication cell MC and can communicate with the moving station MS. However, it is preferable that the three non-moving communication devices 2G, 2H, and 2I are preferentially connected to the other base station 111, 121, or 131, in case there is such other base station 111, 121, or 131 available for communication. This is because the moving station MS moves relative to the non-moving communication devices 2G, 2H and 2I, which may cause unstable communication.

It should be noted that, the fact that the non-moving communication device 2G, 2H, or 2I is outside the vehicle V or that the non-moving communication device 2G, 2H, or 2I is not moving along with the moving station MS is recognized in the core network CN or the like, based on the position information of the moving station MS or the non-moving communication device 2G, 2H, or 2I acquired by the position information acquirer 311 described below, the movement information of the moving station MS or the non-moving communication device 2G, 2H, or 2I acquired by the movement information acquirer 312 described below, the boarding information of the non-moving communication device 2G, 2H, or 2I (i.e., information indicating that it is not boarding on the vehicle V) acquired by the boarding information acquirer 314 or the like. While the moving communication device identifier 32 described below identifies the moving communication device 2M based on such information or the like, the core network CN or the like can identify the non-moving communication devices 2G, 2H, and 2I based on such information.

On the other hand, it is preferable that the three moving communication devices 2M-1, 2M-2, and 2M-3 shown in FIG. 3 are preferentially connected to the moving station MS that moves together. In such a case, the moving station MS functions as a relay station that relays communications between the base stations 111, 121, and 131 (not shown) and the moving communication device 2M. In the following description, it is assumed that only the three moving communication devices 2M-1, 2M-2, and 2M-3 are connected to the moving station MS, and the three non-moving communication devices 2G, 2H, and 2I are not connected to the moving station MS.

In the wireless communication system 1, an emergency information distribution area is set up where emergency information concerning earthquakes, tsunamis or other disasters or the like is distributed simultaneously or broadcasted. A system that distributes the emergency information is called a public warning system (PWS), and also an earthquake and tsunami warning system (ETWS) especially if it distributes warnings concerning disasters such as earthquakes or tsunamis. The emergency information distribution areas are generally set up in units of administrative divisions such as cities, wards, towns, and villages. Each fixed base station 111 and 121 stationarily installed on the ground as shown in FIG. 2 belongs to the emergency information distribution area set up in the administrative division of the place where it is installed.

On the other hand, as schematically shown in FIG. 3, the moving communication cell MC provided by the moving station MS can contain a plurality of different emergency information distribution areas. In the example of FIG. 3, the moving communication cell MC provided by the moving station MS contains two different emergency information distribution areas EA1 and EA2. The boundary line BD is the boundary line between the emergency information distribution areas EA1 and EA2. In the situation shown in the figure, the moving group MG (in particular, the moving station MS and the moving communication device 2M) and the non-moving communication devices 2H and 2I belong to or are located in the first emergency information distribution area EA1 set up in the first administrative division, and the non-moving communication device 2G belongs to or is located in the second emergency information distribution area EA2 set up in the second administrative division.

The emergency information distribution system, which may constitute a portion of the information distributer 38 described below, simultaneously distributes the emergency information to all the communication devices 2 within the emergency information distribution area where a disaster or the like has occurred. Specifically, in case a disaster or the like has occurred in the first emergency information distribution area EA1, the moving station MS belonging to the first emergency information distribution area EA1, distributes the emergency information simultaneously to the moving communication devices 2M within the first emergency information distribution area EA1 and within the moving group MG. And, the base stations 111, 121, and 131 (not shown) belonging to the first emergency information distribution area EA1, distribute the emergency information simultaneously to the non-moving communication devices 2H and 2I within the first emergency information distribution area EA1. On the other hand, in case a disaster or the like has occurred in the second emergency information distribution area EA2, the base stations 111, 121, and 131 (not shown) belonging to the second emergency information distribution area EA2, distribute the emergency information simultaneously to the non-moving communication device 2G within the second emergency information distribution area EA2.

The information acquirer 31, which is preferably provided in the core network CN, acquires various information concerning the communication devices 2, the vehicles V, and the moving stations MS within the moving communication cell MC. In particular, the information acquirer 31 acquires various information concerning the moving communication devices 2M, the vehicles V, and the moving stations MS that constitute the moving group MG. The information acquirer 31 may include at least one of the position information acquirer 311, the movement information acquirer 312, the connection information acquirer 313, and the boarding information acquirer 314.

The position information acquirer 311 acquires the position information of the communication device 2, the vehicle V, and the moving station MS within the moving communication cell MC. As described above, in case the positioning device 43 of the moving station MS is equipped with a satellite positioning device such as a GPS module, its satellite positioning information (i.e., the position information of the moving station MS) may be provided to the core network CN via the parent base station 111, 121, or 131 (not shown). Similarly, in case the communication device 2 or the vehicle V is equipped with a satellite positioning device such as a GPS module, its satellite positioning information (i.e., the position information of the communication device 2 or the vehicle V) may be provided to the core network CN, via the moving station MS to which the moving communication device 2M is connected, or the base station 111, 121, or 131 to which the non-moving communication device 2G, 2H, or 2I is connected (not shown).

The movement information acquirer 312 acquires the movement information of the communication device 2, the vehicle V, and the moving station MS within the moving communication cell MC. Examples of the movement information include a movement route, arrival time at each location on the movement route, velocity, acceleration, and movement direction. Some or all of the movement information can be acquired from the communication device 2, the vehicle V, the moving station MS themselves, or a movement instruction device (not shown) that remotely gives movement instruction to the vehicle V or a public transportation such as a bus or a train. For example, the movement route and the arrival time at each location on the movement route can be acquired from a map application or a navigation application installed in the communication device 2, the vehicle V, the moving station MS, or the movement instruction device or the like. Besides, the velocity, the acceleration, and the movement direction can be acquired from a positioning device such as a GPS module that also functions as the position information acquirer 311.

It should be noted that, as for the moving communication device 2M, the vehicle V, and the moving station MS that constitute the moving group MG, it may be already identified by the moving communication device identifier 32 that they constitute the moving group MG based on other information. In such a case, the movement information acquirer 312 may acquire the movement information of any of the moving communication device 2M, the vehicle V, and the moving station MS, as the representative movement information of the moving group MG.

The connection information acquirer 313 acquires the connection information between the communication device 2 and the moving station MS within the moving communication cell MC. As described above, in the example of the present embodiment, only the three moving communication devices 2M-1, 2M-2, and 2M-3 are connected to the moving station MS. Therefore, the connection information acquirer 313 acquires the connection information indicating that the moving communication device 2M in the vehicle V is connected to the moving station MS. Similarly, the connection information acquirer 313 may acquire the connection information indicating that the non-moving communication devices 2G, 2H, and 21 outside the vehicle V are not connected to the moving station MS (are connected to the other base stations 111, 121, or 131).

The boarding information acquirer 314 acquires the boarding information of a boarding user (not shown) who is a user of the moving communication device 2M to the vehicle V. For example, the boarding information of the boarding user to the vehicle V is acquired by the boarding information acquirer 314, such as the information indicating that the boarding user has conducted a check-in or a boarding procedure using the moving communication device 2M when boarding on the vehicle V (e.g., the information indicating that the boarding user has placed the moving communication device 2M over a contactless reader installed on a ticket gate or a boarding gate of the vehicle V as public transportation, or the information indicating that the boarding user has paired the moving communication device 2M with the vehicle V for navigation or playing music or the like through it when boarding on a private car), or the information indicating that the boarding user has purchased online a boarding ticket for the vehicle V as public transportation using an account to which the moving communication device 2M is linked.

The moving communication device identifier 32 identifies the moving communication device 2M that moves along with the moving station MS, based on some or all of the various information acquired by the information acquirer 31.

The moving communication device identifier 32 may detect that the moving communication device 2M moves along with the moving station MS, based on the position information of the moving station MS and the moving communication device 2M acquired by the position information acquirer 311. For example, in case the relative distance (absolute value), which is the difference between the position information of the moving station MS and the position information of the moving communication device 2M, is less than a predetermined value over a predetermined period of time, the moving communication device identifier 32 may determine that the moving communication device 2M is moving along with the moving station MS.

The moving communication device identifier 32 may detect that the moving communication device 2M moves along with the moving station MS, based on the movement information of the moving station MS and the moving communication device 2M acquired by the movement information acquirer 312. For example, in case the difference between the movement information of the moving station MS and the movement information of the moving communication device 2M is less than a predetermined value over a predetermined period of time, the moving communication device identifier 32 may determine that the moving communication device 2M is moving along with the moving station MS.

The moving communication device identifier 32 may detect that the moving communication device 2M moves along with the moving station MS, based on the connection information between the moving communication device 2M and the moving station MS acquired by the connection information acquirer 313. For example, based on the connection information indicating that the moving communication device 2M in the vehicle V is connected to the moving station MS, the moving communication device identifier 32 may determine that the moving communication device 2M is moving along with the moving station MS.

The moving communication device identifier 32 may detect that the moving communication device 2M used by a boarding user moves along with the moving station MS, based on the boarding information of the boarding user to the vehicle V acquired by the boarding information acquirer 314. For example, based on the boarding information indicating that the boarding user is on the vehicle V, the moving communication device identifier 32 may determine that the moving communication device 2M is moving along with the moving station MS.

The emergency information distribution area setter 33 sets the emergency information distribution area for the moving station MS or the communication device 2, based on the position information of the moving station MS or the communication device 2 acquired by the position information acquirer 311, or the movement information of the moving station MS or the communication device 2 acquired by the movement information acquirer 312. In the illustrated example, the emergency information distribution area setter 33 may set the first emergency information distribution area EA1 for the moving station MS, in accordance with the position information of the moving station MS acquired by the position information acquirer 311 indicating a position within the first emergency information distribution area EA1. In such a case, the emergency information distribution area setter 33 may set the same first emergency information distribution area EA1 as the moving station MS, for the moving communication device 2M that moves along with the moving station MS.

Alternatively, the emergency information distribution area setter 33 may set the first emergency information distribution area EA1 in the area on one side of the boundary line BD (on the left side in FIG. 3) within the moving communication cell MC, and the second emergency information distribution area EA2 in the area on another side of the boundary line BD (on the right side in FIG. 3) within the moving communication cell MC, based on the position information of the moving station MS, the placement information of the boundary line BD, the range information of the moving communication cell MC or the like acquired by the position information acquirer 311. In such a case, the emergency information distribution system, which may constitute a portion of the information distributer 38 described below, can distribute emergency information concerning the first emergency information distribution area EA1 to the moving communication device 2M and the non-moving communication devices 2H and 2I within the first emergency information distribution area EA1, and emergency information concerning the second emergency information distribution area EA2 to the non-moving communication device 2G within the second emergency information distribution area EA2.

Similarly, the emergency information distribution area setter 33 may set the first emergency information distribution area EA1 for the moving communication device 2M and the non-moving communication devices 2H and 21, in accordance with the position information of the communication devices 2M 2H, and 2I acquired by the position information acquirer 311 indicating positions within the first emergency information distribution area EA1. The emergency information distribution area setter 33 may set the second emergency information distribution area EA2 for the non-moving communication device 2G, in accordance with the position information of the communication device 2G acquired by the position information acquirer 311 indicating a position within the second emergency information distribution area EA2.

FIG. 4 schematically shows an example of processes by the position information acquirer 311 and the emergency information distribution area setter 33. In the figure, time flows from top to bottom. In the example, various data is sequentially exchanged among “IAB” such as the moving station MS, “RAN” (Radio Access Network) such as the base station 111, 121, or 131, “CN/CBS” such as the core network CN or the CBS (Cell Broadcast Service) provided by it, and “NWDAF” such as the NWDAF (Network Data Analytics Function) which may be a portion of the core network CN. “S” in the figure means a step or a process.

In S1, under the position information acquirer 311, “IAB” transmits the position information of the moving station MS to “RAN”, when a new moving station MS is installed (installation), the moving station MS or the moving group MG moves (movement) as schematically indicated by the arrow representing the movement route RT in FIG. 3, or the emergency information distribution area transitions by the movement (in the movement example of FIG. 3, the transition is from the first emergency information distribution area EA1 to the second emergency information distribution area EA2). In such a way, the moving station MS may be movable across the different emergency information distribution areas EA1 and EA2.

In S2, under the position information acquirer 311, “RAN” transmits the position information of the moving station MS transmitted to “RAN” in S1 to “CN/CBS” in the form of a location report (Location Report). The position information of the moving station MS that “CN/CBS”, which may constitute the position information acquirer 311, acquires through S1 and S2 may be measured by the positioning device 43 of the moving station MS such as a GPS module, or it may be estimated or measured by the parent base station 111, 121, or 131 or the like as “RAN”, through communication radio waves or positioning electromagnetic waves emitted to the moving station MS as “IAB”, as described above.

In S3, under the emergency information distribution area setter 33, “CN/CBS” requests “NWDAF” for movement analysis of the moving station MS (Mobility Analytics) based on the position information of the moving station MS acquired in S2. In S4, under the emergency information distribution area setter 33, “NWDAF” performs the movement analysis of the moving station MS in response to the request in S3, and provides “CN/CBS” with the emergency information distribution area (Warning Area) of the moving station MS at the present time or future time, which is set based on the result of the movement analysis.

Here, “NWDAF” may be an Artificial Intelligence (AI)/Machine Learning (ML) function in the core network CN. The AI/ML function may identify the emergency information distribution area in which the moving station MS is located at each time in present or future, through holistic analysis of the present or past position information of the moving station MS acquired in S2, the movement information acquired by the movement information acquirer 312, and other various available relevant information (e.g., placement information of the boundary line BD or range information of the moving communication cell MC).

As such, the emergency information distribution area setter 33 can be configured by various AI/ML functions in the core network CN, such as the NWDAF introduced in 5GC. The NWDAF is responsible for collecting and analyzing data on the 5G network or other networks. Specifically, the NWDAF collects and accumulates activity history information, movement information, measurement information or the like of the moving stations MS or the communication devices 2 connected to the mobile communication network, and utilizes the analysis results for traffic control on the mobile communication network or the like. The analysis function of the movement information of the moving stations MS or the communication devices 2 provided by the NWDAF is also referred to as movement analysis (Mobility Analytics) as described above. It should be noted that, in other wireless communication systems including generations after 5G, functions similar to the NWDAF may be provided under different names. Such similar functions may be utilized instead of or in addition to the NWDAF in the present embodiment.

In FIG. 3, the emergency information acquirer 34 acquires emergency information concerning the emergency information distribution area in which the moving station MS or the communication device 2 is located. For example, the emergency information acquirer 34 may acquire the emergency information concerning the emergency information distribution area set by the emergency information distribution area setter 33 (S3 and S4 in FIG. 4) based on the position information of the moving station MS acquired by the position information acquirer 311 (S1 and S2 in FIG. 4). Besides, the emergency information acquirer 34 may acquire the emergency information concerning the emergency information distribution area set by the emergency information distribution area setter 33 based on the position information of each communication device 2 acquired by the position information acquirer 311.

In the example of FIG. 3, in case the emergency information distribution area setter 33 sets the first emergency information distribution area EA1 in which the moving station MS is located, for the moving station MS or the moving communication device 2M, the emergency information acquirer 34 may acquire only emergency information concerning the first emergency information distribution area EA1. On the other hand, in case the emergency information distribution area setter 33 sets the first emergency information distribution area EA1 for the non-moving communication devices 2H and 2I within the first emergency information distribution area EA1, and sets the second emergency information distribution area EA2 for the non-moving communication device 2G within the second emergency information distribution area EA2, the emergency information acquirer 34 may acquire the emergency information concerning both the emergency information distribution areas EA1 and EA2. In either case, the emergency information acquired by the emergency information acquirer 34 is just outline information common to the emergency information distribution area, which is generally set up in units of administrative divisions such as cities, wards, towns, and villages (e.g., “an earthquake of magnitude X occurred at HH:MM in B City, A Prefecture”).

In the present embodiment, in addition to or instead of such emergency information that is just outline information in units of administrative divisions, the movement warning information concerning the emergency information is distributed, which is highly relevant to the moving communication device 2M that moves along with the moving station MS. Here, the movement warning information is information that communicates concrete warnings to the user (the boarding user) of the moving communication device 2M or a driver of the vehicle V or the like, when the moving communication device 2M, the vehicle V, and the moving station MS, which constitute the moving group MG, are moving in an emergency situation when emergency information is distributed simultaneously. The details will be described below, but in case the emergency information acquired by the emergency information acquirer 34 is to notify the occurrence of an earthquake, the movement warning information may, for example, notify the moving communication device 2M in the vehicle V of a landslide L that has occurred on the movement route RT of the moving group MG in relation to the earthquake.

In order to provide more relevant movement warning information to the moving communication device 2M, the route condition detector 36 may detect the condition of the movement route RT of the moving group MG including the moving station MS and the moving communication device 2M. In order to enable more accurate detection of the condition, the route condition detector 36 may be configured by an AI/ML function such as the NWDAF that can access and analyze a vast amount of data concerning the present or past condition (e.g., weather, terrain, traffic volume, or road surface condition) of the movement route RT to be detected.

In the example of FIG. 3, the route condition detector 36 detects that the moving group MG within the first emergency information distribution area EA1 is moving along the movement route RT. The movement route RT can be acquired by the movement information acquirer 312 and may be set in a map application, a route search application, or a navigation device of at least one of the moving communication device 2M, the vehicle V, or the moving station MS that constitutes the moving group MG. Alternatively, the movement route RT may be estimated from changes over time in the position information of at least one of the moving communication device 2M, the vehicle V, or the moving station MS that can be acquired by the position information acquirer 311, and from known placement information of major roads. Furthermore, the route condition detector 36 detects that a road on the movement route RT is impassable due to the landslide L caused by the earthquake pertaining to the emergency information. It should be noted that the location of the landslide L may be outside the first emergency information distribution area EA1 (in the example of FIG. 3, inside the second emergency information distribution area EA2) in which the moving group MG is currently located, or outside the current moving communication cell MC.

Besides, the route condition detector 36 may detect not only a secondary disaster such as the landslide L, but also congestion or the like of the movement route RT or alternative routes due to an earthquake or the like as a primary disaster. Furthermore, in case the vehicle V is a train, the route condition detector 36 may detect impassable sections or suspended sections due to an earthquake or the like on the railway track as its movement route RT.

The movement warning information generator 35 generates movement warning information concerning the emergency information acquired by the emergency information acquirer 34, and also concerning the movement of at least one of the moving station MS and the moving communication device 2M (i.e., the moving group MG). The movement warning information generator 35 may be configured by an AI/ML function such as the NWDAF that can access and analyze a vast amount of data concerning the present or past condition of the moving communication device 2M or the moving station MS, in order to enable the generation of the movement warning information that is highly relevant to the moving communication device 2M or the like.

The movement warning information generator 35 may generate the movement warning information for the moving communication device 2M, based on the condition of the movement route RT of the moving group MG detected by the route condition detector 36. In the example of FIG. 3, the movement warning information generator 35 generates the movement warning information to alert the moving communication device 2M, which is moving along the movement route RT toward the destination D, that the landslide L has occurred on the movement route RT, or that the road is impassable. The movement warning information may suggest a recommended detour route to the moving communication device 2M.

Besides, in case the vehicle V is a train, the movement warning information generator 35 generates the movement warning information to alert the moving communication device 2M used by its passenger (the boarding user) that there is an impassable section on the current movement route RT due to an earthquake or the like. The movement warning information may suggest to the moving communication device 2M, a recommended station or place to get off, or alternative public transportation to reach the destination D.

The movement warning information generator 35 may generate the movement warning information in accordance with the number of the boarding users detected by the boarding user number detector 37. The boarding user number detector 37 detects the number of the boarding users on the vehicle V, based on some or all of various information acquired by the information acquirer 31. For example, the boarding user number detector 37 may detect the number of the boarding users on the vehicle V, based on the connection information between the moving communication devices 2M and the moving station MS acquired by the connection information acquirer 313. In the example of FIG. 3, the three moving communication devices 2M-1, 2M-2, and 2M-3 are connected to the moving station MS, therefore the boarding user number detector 37 may determine that the number of the boarding users is “3”.

In case the vehicle V is a private car, the number of the boarding users detected by the boarding user number detector 37 is small, and the vehicle V itself is considered to be relatively small. Therefore, the movement warning information generator 35 may suggest a relatively narrow road as a detour route. In case the vehicle V is a train, and the number of the boarding users detected by the boarding user number detector 37 is large, the movement warning information generator 35 may suggest a recommended station or place to get off to avoid congestion during evacuation, or may present warnings during the evacuation.

The information distributer 38 distributes the movement warning information generated by the movement warning information generator 35 from the moving station MS to the moving communication device 2M. In addition to the movement warning information, the information distributer 38 may distribute the emergency information acquired by the emergency information acquirer 34 from the moving station MS to the moving communication device 2M.

In the example of FIG. 3, the information distributer 38 may distribute, from the moving station MS to the moving communication device 2M that is moving along the movement route RT toward the destination D, the movement warning information concerning the landslide L that has occurred on the movement route RT, together with the emergency information concerning the second emergency information distribution area EA2 where the landslide L has occurred. Alternatively, the information distributer 38 may distribute, from the moving station MS to the moving communication device 2M that is moving along the movement route RT toward the destination D, the movement warning information concerning the landslide L that has occurred on the movement route RT, together with the emergency information concerning the first emergency information distribution area EA1 where the moving communication device 2M is currently located.

It should be noted that an API (Application Programming Interface) may be provided to allow a third party with access right to set the conditions under which the information distributer 38 distributes the movement warning information, or the contents of the movement warning information to be generated by the movement warning information generator 35.

According to the present embodiment, in an emergency situation where the emergency information is distributed simultaneously, the movement warning information concerning the movement is distributed from the moving station MS to the moving communication device 2M that moves along with the moving station MS. The movement warning information is more relevant to the moving communication device 2M than the emergency information that is distributed simultaneously within each of the emergency information distribution areas EA1 and EA2.

The present disclosure has been described above based on embodiments. It is obvious to those skilled in the art that various variations are possible in combinations of each component or each process disclosed in the exemplary embodiments, and that such variations are also encompassed within the scope of the present disclosure.

It should be noted that the structures, the operations, or the functions of each apparatus or each method described in the embodiments can be realized by hardware resources or software resources, or by cooperation of hardware resources and software resources. Processors, ROMs, RAMs, or various integrated circuits, for example, can be used as hardware resources. Programs such as operating systems and applications, for example, can be used as software resources.

The present disclosure may be expressed as following items.

### Item 1:

A communication control apparatus comprising at least one processor that performs:
causing an emergency information acquirer to acquire emergency information concerning an emergency information distribution area in which a movable moving station is located;
causing a moving communication device identifier to identify a moving communication device that moves along with the moving station;
causing a movement warning information generator to generate movement warning information concerning the emergency information and the movement of at least one of the moving station and the moving communication device; and
causing an information distributer to distribute the movement warning information from the moving station to the moving communication device.

### Item 2:

The communication control apparatus according to item 1, wherein the information distributer distributes the emergency information and the movement warning information from the moving station to the moving communication device.

### Item 3:

The communication control apparatus according to item 1 or 2, wherein
the at least one processor performs, causing a route condition detector to detect the condition of the route of the moving station, and wherein
the movement warning information generator generates the movement warning information based on the condition of the route.

### Item 4:

The communication control apparatus according to any of items 1 to 3, wherein
the moving station is attached to a vehicle, and wherein
the moving communication device is used by a boarding user in the vehicle.

### Item 5:

The communication control apparatus according to item 4, wherein
the at least one processor performs, causing a boarding user number detector to detect the number of the boarding users, and wherein
the movement warning information generator generates the movement warning information in accordance with the number of the boarding users.

### Item 6:

The communication control apparatus according to item 5, wherein
the at least one processor performs, causing a connection information acquirer to acquire connection information between the moving communication device and the moving station, and wherein
the boarding user number detector detects the number of the boarding users based on the connection information.

### Item 7:

The communication control apparatus according to any of items 4 to 6, wherein
the at least one processor performs, causing a boarding information acquirer to acquire boarding information of the boarding user to the vehicle, and wherein
the moving communication device identifier detects, based on the boarding information, that the moving communication device moves along with the moving station.

### Item 8:

The communication control apparatus according to any of items 1 to 7, wherein
the at least one processor performs, causing a position information acquirer to acquire position information of the moving station and the moving communication device, and wherein
the moving communication device identifier detects, based on the position information of the moving station and the moving communication device, that the moving communication device moves along with the moving station.

### Item 9:

The communication control apparatus according to any of items 1 to 8, wherein
the at least one processor performs, causing a movement information acquirer to acquire movement information of the moving station and the moving communication device, and wherein
the moving communication device identifier detects, based on the movement information of the moving station and the moving communication device, that the moving communication device moves along with the moving station.

### Item 10:

The communication control apparatus according to any of items 1 to 9, wherein
the at least one processor performs, causing a connection information acquirer to acquire connection information between the moving communication device and the moving station, and wherein
the moving communication device identifier detects, based on the connection information between the moving communication device and the moving station, that the moving communication device moves along with the moving station.

### Item 11:

The communication control apparatus according to any of items 1 to 10, wherein the movement warning information generator is configured by the NWDAF (Network Data Analytics Function).

### Item 12:

The communication control apparatus according to any of items 1 to 11, wherein the moving station is movable across different emergency information distribution areas.

### Item 13:

The communication control apparatus according to any of items 1 to 12, wherein the moving station is a relay station that relays communication between a base station and the moving communication device.

### Item 14:

The communication control apparatus according to item 13, wherein the relay station is the IAB (Integrated Access and Backhaul) node equipped with the MT (Mobile Termination) that functions as a communication device for the base station and the DU (Distributed Unit) that functions as a base station for the moving communication device.

### Item 15:

A communication control method causing at least one processor to perform:
acquiring emergency information concerning an emergency information distribution area in which a movable moving station is located;
identifying a moving communication device that moves along with the moving station;
generating movement warning information concerning the emergency information and the movement of at least one of the moving station and the moving communication device; and
distributing the movement warning information from the moving station to the moving communication device.

### Item 16:

A computer-readable medium storing a communication control program causing at least one processor to perform:
acquiring emergency information concerning an emergency information distribution area in which a movable moving station is located;
identifying a moving communication device that moves along with the moving station; generating movement warning information concerning the emergency information and the movement of at least one of the moving station and the moving communication device; and distributing the movement warning information from the moving station to the moving communication device.

### Industrial Applicability

The present disclosure relates to distribution of movement warning information for communication device moving along with moving station.

### REFERENCE SIGNS LIST

1 wireless communication system, 2 communication device, 2M moving communication device, 3 communication control apparatus, 11 5G wireless communication system, 12 4G wireless communication system, 13 satellite communication system, 31 information acquirer, 32 moving communication device identifier, 33 emergency information distribution area setter, 34 emergency information acquirer, 35 movement warning information generator, 36 route condition detector, 37 boarding user number detector, 38 information distributer, 41 communication-device function device, 42 base-station function device, 43 positioning device, 111 5G base station, 112 5G cell, 121 4G base station, 122 4G cell, 131 communication satellite, 132 satellite communication cell, 133 gateway, 311 position information acquirer, 312 movement information acquirer, 313 connection information acquirer, 314 boarding information acquirer.

1. A communication control apparatus comprising at least one processor that performs:
causing an emergency information acquirer to acquire emergency information concerning an emergency information distribution area in which a movable moving station is located;
causing a moving communication device identifier to identify a moving communication device that moves along with the moving station;
causing a movement warning information generator to generate movement warning information concerning the emergency information and the movement of at least one of the moving station and the moving communication device; and
causing an information distributer to distribute the movement warning information from the moving station to the moving communication device.

2. The communication control apparatus according to claim 1, wherein the information distributer distributes the emergency information and the movement warning information from the moving station to the moving communication device.

3. The communication control apparatus according to claim 1, wherein
the at least one processor performs, causing a route condition detector to detect the condition of the route of the moving station, and wherein
the movement warning information generator generates the movement warning information based on the condition of the route.

4. The communication control apparatus according to claim 1, wherein
the moving station is attached to a vehicle, and wherein
the moving communication device is used by a boarding user in the vehicle.

5. The communication control apparatus according to claim 4, wherein
the at least one processor performs, causing a boarding user number detector to detect the number of the boarding users, and wherein
the movement warning information generator generates the movement warning information in accordance with the number of the boarding users.

6. The communication control apparatus according to claim 5, wherein
the at least one processor performs, causing a connection information acquirer to acquire connection information between the moving communication device and the moving station, and wherein
the boarding user number detector detects the number of the boarding users based on the connection information.

7. The communication control apparatus according to claim 4, wherein
the at least one processor performs, causing a boarding information acquirer to acquire boarding information of the boarding user to the vehicle, and wherein
the moving communication device identifier detects, based on the boarding information, that the moving communication device moves along with the moving station.

8. The communication control apparatus according to claim 1, wherein
the at least one processor performs, causing a position information acquirer to acquire position information of the moving station and the moving communication device, and wherein
the moving communication device identifier detects, based on the position information of the moving station and the moving communication device, that the moving communication device moves along with the moving station.

9. The communication control apparatus according to claim 1, wherein
the at least one processor performs, causing a movement information acquirer to acquire movement information of the moving station and the moving communication device, and wherein
the moving communication device identifier detects, based on the movement information of the moving station and the moving communication device, that the moving communication device moves along with the moving station.

10. The communication control apparatus according to claim 1, wherein
the at least one processor performs, causing a connection information acquirer to acquire connection information between the moving communication device and the moving station, and wherein
the moving communication device identifier detects, based on the connection information between the moving communication device and the moving station, that the moving communication device moves along with the moving station.

11. The communication control apparatus according to claim 1, wherein the movement warning information generator is configured by the NWDAF (Network Data Analytics Function).

12. The communication control apparatus according to claim 1, wherein the moving station is movable across different emergency information distribution areas.

13. The communication control apparatus according to claim 1, wherein the moving station is a relay station that relays communication between a base station and the moving communication device.

14. The communication control apparatus according to claim 13, wherein the relay station is the IAB (Integrated Access and Backhaul) node equipped with the MT (Mobile Termination) that functions as a communication device for the base station and the DU (Distributed Unit) that functions as a base station for the moving communication device.

15. A communication control method causing at least one processor to perform:
acquiring emergency information concerning an emergency information distribution area in which a movable moving station is located;
identifying a moving communication device that moves along with the moving station;
generating movement warning information concerning the emergency information and the movement of at least one of the moving station and the moving communication device; and
distributing the movement warning information from the moving station to the moving communication device.

16. A computer-readable medium storing a communication control program causing at least one processor to perform:
acquiring emergency information concerning an emergency information distribution area in which a movable moving station is located;
identifying a moving communication device that moves along with the moving station;
generating movement warning information concerning the emergency information and the movement of at least one of the moving station and the moving communication device; and
distributing the movement warning information from the moving station to the moving communication device.
